(19) United States
(12) Patent Application Publication
(10) Pub. No.: US 2021/0388634 A1
(43) Pub. Date: Dec. 16, 2021

(54) Door Latch Device

(71) Applicant: Elizabeth Wangley, St. Louis, MO (US)

(72) Inventor: Elizabeth Wangley, St. Louis, MO (US)

(21) Appl. No.: 16/902,241

(22) Filed: Jun. 15, 2020

(51) Int. Cl. E05B 1/00; E05B 53/00

(52) U.S. Cl. CPC E05B 1/0053; E05B 1/0084; E05B 53/001

(57) ABSTRACT

A door latch operating device that is a safer door handle alternative to a traditional door knob or handle. This device includes a door handle offering numerous surfaces that a person can use to operate the door latch using his or her foot, elbow, knee or handy object such as an umbrella or handbag

### CROSS-REFERENCE TO RELATED APPLICATIONS

Not Applicable

### STATEMENT REGARDING FEDERALLY SPONSORED RESEARCH

Not Applicable

### THE NAMES OF THE PARTIES TO A JOINT RESEARCH AGREEMENT

Not Applicable

### STATEMENT REGARDING PRIOR DISCLOSURES BY THE INVENTOR OR A JOINT INVENTOR

Not Applicable

### BACKGROUND OF THE INVENTION

Doors latch mechanisms such as door knobs or door handles are intended for use by hand. Health experts have stressed that door knobs are one of the methods infectious diseases such as Covid-19 can be spread. During the height of the pandemic, it was not uncommon to see people doing their utmost best to avoid using their hands operating doors, resorting to using elbows, knees and even feet. Whereas unlocked push doors can be pushed open using the foot, latched doors present a more formidable challenge when the door needs to be pulled.

### FIELD OF THE INVENTION

This invention relates to the field of door latches and more particularly, devices and methods to insure the safe operation of doors.

### DESCRIPTION OF RELATED ART

Door knobs and door handles are ubiquitous in everyday life. To open a door, the door handle must first be rotated fully and then the door is either pushed or pulled depending on the swing direction of the door.

The COVID-19 pandemic brought to light the dangers of disease transmittal through hand contact with public doors. The revelation that viruses can linger on metal and other surfaces has raised concerns about the use of door knobs and door handles. People have been observed using protective gloves and paper towels to operate doors.

U.S. Patent Application Publication No. 2017/0218661 describes a foot operated door latch incorporating a foot pedal to rotate a door knob.

### BRIEF SUMMARY OF THE INVENTION

The present invention is a door latch handle that can be conveniently operated by foot, knee, elbow, as well as by hand and hand-held objects such as an umbrella.

The present invention is a door latch operating device for use on most types of hinged doors and sliding doors. Embodiments of this invention are designed to be used on any type of a door latch or dead bolt latch.

The embodiments of the device disclosed herein by the steps of providing a door latch which is operated by moving a multi surfaced plate instead of a handle. The plate can be of an item of art or logo made from a suitable material which inherently offer a multitude of projections and voids which are convenient for a person to operate using for example, a foot or umbrella. Furthermore, the axis of rotation is vertical whereas the prior art the axis of rotation is horizontal.

### BRIEF DESCRIPTION OF THE SEVERAL VIEWS OF THE DRAWINGS

FIG. 1 shows a perspective view of one embodiment of the door latch device according to the present invention as installed on a door:

FIG. 2 shows a perspective view of one embodiment of the door latch device as installed on a door and being used by an operator.

FIG. 3 shows a perspective view of the door latch device without being installed onto the door.

FIG. 4 shows a top view of the door latch device without being installed onto the door.

FIG. 5 shows a bottom view of the door latch device without being installed onto the door.

### DETAILED DESCRIPTION OF THE INVENTION

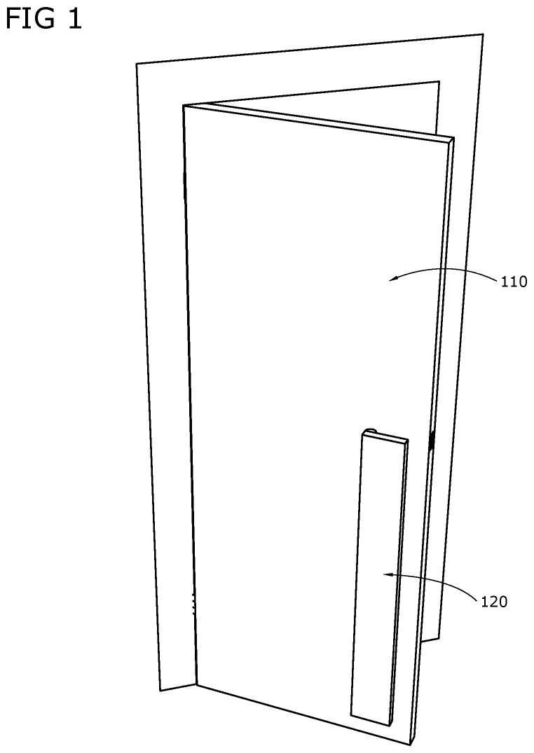

FIG. 1 illustrates a door latch device 100 according to the present invention installed in a swinging door 110. The door latch device 100 includes a pull side compound handle 120.

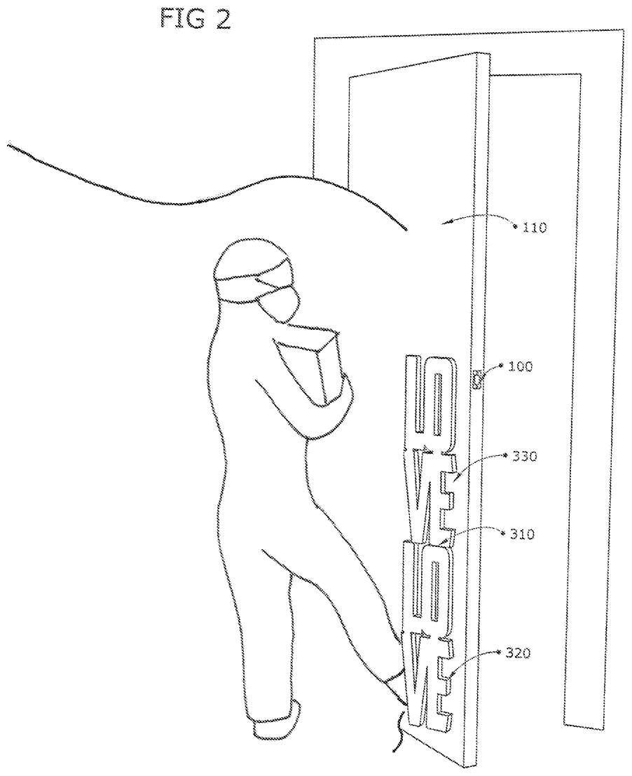

FIG. 2 shows a perspective view of a second embodiment of the door latch device 100 according to the present invention while being operated by a person. In this embodiment, the pull side compound handle 120 of FIG. 1 is replaced by a functional piece of art 310. The functional piece of art 310 inherently provides for numerous protrusions 320 and voids 330 which can be used to operate the door latch device 100.

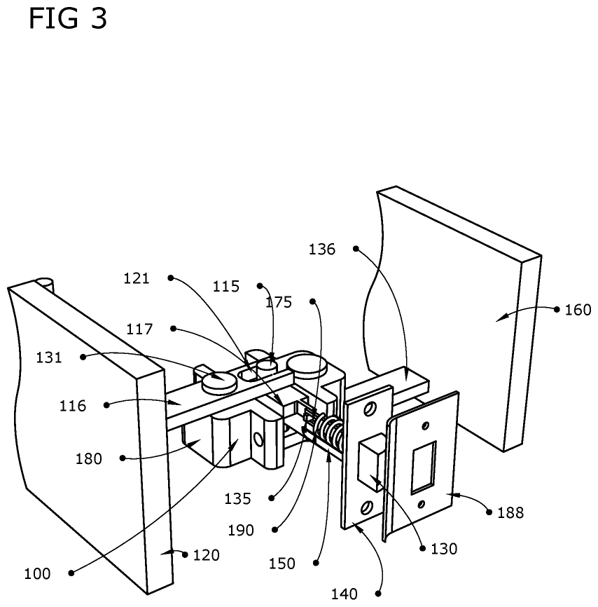

FIG. 3 is a perspective view of the door latch device as removed from the door 110 and with some portions shown in cutaway and other portions such as screws and housing not shown. The portions not shown will be obvious to those skilled in the art.

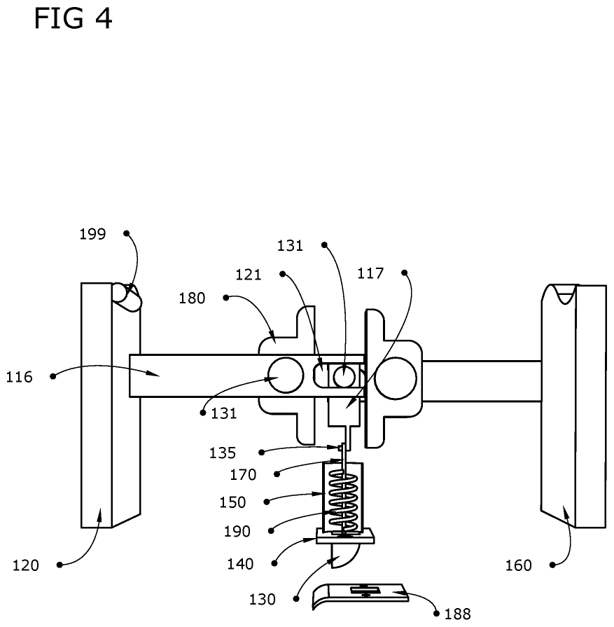

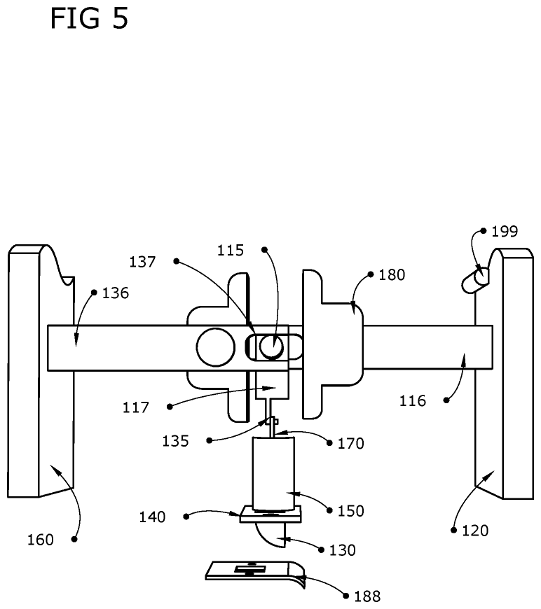

In the particular embodiment depicted in FIG. 3-5, the main portion consists of a latch bolt 170 with a latch 130 on the distal end and a hub assembly 117 on the proximal end. A hub 115 is formed on to the hub assembly 117. A hook 135 is formed on the distal end of the hub assembly 117. A slot 175 is formed on to the distal end of the latch bolt 170. The hook 135 engages in the slot 175 such that the latch 130 can freely extend and retract fully. A spring 190 is positioned within the latch assembly 150 such that the latch is normally extended and engaging with strike plate 188 to keep door 110, when pushed shut, to stay closed.

An edge mounting plate 140 is one of the means by which the door latch device 100 is attached to the door 110.

FIG. 1 shows a compound handle 120 which is the door handle that a user would use to operate the door. In this embodiment, the compound handle 120 is a functional artwork which could be made from a strong material that is also attractive such as brass. The distal end of lever arm 116 is attached to the rear of the compound handle 120. A slot 121 is formed at the proximal end lever arm 116 and is sized and positioned to engage with hub 115. The lever arm 116 is rotationally attached to pivot shaft 131 and pivot mount bracket 180. The pivot mount bracket 180 is attached to door 110.

FIG. 3-5 also shows push side compound handle 160 which is the corollary of pull side compound handle 120. In this particular embodiment, the push side compound handle also connects to hub assembly 117 in the same manner as pull side compound handle 120 does except through the bottom side of hub assembly 117. In his embodiment, both the push side compound handle 160 and pull side compound handle 120 are connected to the same hub assembly 117 through slot 137. The result is that both the push side compound handle 160 and pull side compound handle 120 will move in sync with each other. As such, an added benefit is that a person can be forewarned that a door is imminently about to open when the door handle moves due to the operation of the door latch by a person on the other side of the door.

A friction surface 199 in affixed to the end of pull side compound handle 120. This friction surface 199 in this embodiment is shaped in generally a semi-circle and it functions as a suitable surface on the pull side compound handle 120 for a foot or elbow to latch on to making it easier to pull open the door 110.

A consideration for the particular embodiment of the door latch device shown in FIG. 1-5 is whether the single pivot configuration as shown in FIG. 3 as pivot 131 is adequate to support the weight and load of compound handle 120. Hence, another embodiment of this invention is advanced where instead of the single lever arm 116, the single pivot 131 and single pivot mount bracket 180, a multitude of co-axial lever arms, pivots and pivot mount brackets provide a sturdier door latch device able to withstand the abuses of public use.

The inconvenience of operating doors without using hands is greater when the operator is on the side of the door requiring him or her to pull at the door. For example, a person exiting a house that has an in-swinging door or entering a house that has an out-swinging door has the added obstacle of pulling the door handle once they have unlatched the door. Opening a conventional prior art door generally requires the user to unlatch the door first by turning the door knob or door handle. Once the door is unlatched, it becomes free to swing open. When opening a door requires two motions, the first is to operate the latch via the door knob or handle to disengage the latch and free the door, and the second is to either push or pull the door in accordance with the swinging direction of the door. Pulling or pushing the door prior to operating the door latch will make it difficult to then operate the latch.

The most ubiquitous prior art door latch is the generally spherical or cylindrical door knob. These are almost impossible to operate without using a hand. A more practical variant of the door knob is the door handle which is in the shape of a short lever. For a prior art door latch with a door handle and with the operator on the side of the door where the door would have to be pushed open, it is possible to operate the door handle with an elbow to press down the door handle and following that, to push the door open using a knee, foot or body. In this scenario, if the user was on the other side of the door, he or she could still use the elbow to press down on the handle, and contort the elbow into a hook shape to engage the door handle and pull the door open. However, there is typically only approximately 2 inches of space between the door handle and the door.

The present invention seeks to provide relief for door users who wish to avoid hand contact with a commonly used surface. The everyday door knob or handle is replaced by a considerably larger device that is easier to operate using a foot, knee or elbow. Firstly, the physical interface to operate the door is no longer an approximately 3-inch cylindrical object or a short lever. Instead, the compound handle 120 is amply sized and inherently offers a variety of ways to operate. Furthermore, the axis of rotation is vertical instead of horizontal. This change of direction is more conducive to ease of operation. Consider the situation of a person carrying two bags of groceries at a door fitted with the present door latch device with the door hinge towards the person's left, the door latch device towards the right and assuming the door swings towards the person. That person will find it convenient and intuitive to use a knee to turn the compound handle towards the right until a physical limit is felt, and then use a foot to pull the door open. Alternatively, if the door is swinging away, the person could just as easily nudge the door open with any part of the body. This door latch device makes any door more accessible to the general public and is a boon for persons with physical disabilities.

What is claimed is:

1. A door latch device, comprising:
a latch housing:
a bolt having a longitudinal axis, a proximal end having a cam, said cam being generally in the vertical axis, and a distal end having a latch;
a handle assembly with a distal end having a handle plate, and a proximal end having a slot for engaging said cam; and
said handle plate, said cam and said bolt being moveable together in the horizontal plane from an outward position wherein latch extends from said latch housing, to an actuated position wherein the latch is retracted into said latch housing.

2. The door latch device according to claim 1, wherein said handle plate further comprising a plurality of protrusions.

3. The door latch device according to claim 1, wherein said handle plate further comprising a plurality of patterns, designs, logos or other markings.

4. The door latch device according to claim 1, wherein said handle plate further comprising a friction surface.

5. The door latch device according to claim 2, wherein said handle plate further comprising a friction surface.

6. The door latch device according to claim 3, wherein said handle plate further comprising a friction surface.
